(19) United States
(12) Patent Application Publication
(10) Pub. No.: US 2018/0281768 A1
(43) Pub. Date: Oct. 4, 2018

(54) METHOD OF MONITORING AIRCRAFT BRAKE PERFORMANCE AND APPARATUS FOR PERFORMING SUCH A METHOD

(71) Applicant: AIRBUS OPERATIONS LIMITED, Bristol (GB)

(72) Inventor: John WINGATE, Bristol (GB)

(21) Appl. No.: 15/912,342

(22) Filed: Mar. 5, 2018

Related U.S. Application Data
(63) Continuation of application No. 13/029,333, filed on Feb. 17, 2011, now abandoned.

(30) Foreign Application Priority Data
Dec. 21, 2010 (GB) 1021545.7

(51) Int. Cl. B60T 17/22; F01D 5/02; B60T 8/17; F02C 3/073; F01D 5/08; B64C 25/42

(52) U.S. Cl. CPC B60T 17/22; F01D 5/022; B60T 8/1703; F02C 3/073; Y02T 50/676; F01D 5/025; B60T 8/17; F01D 5/021; B64C 25/42; F01D 5/08

(57) ABSTRACT

A brake performance monitoring system operates by an energy differential calculated from brake demand energy and energy absorbed during a braking operation. A significant differential would be reported as a possible problem with the braking system.

The present invention is concerned with a method of monitoring vehicle wheel brake performance, and an apparatus for performing such a method. More specifically, the present invention is concerned with a method of monitoring aircraft landing gear brake performance, and an apparatus for performing such a method.

A significant proportion of aircraft braking is performed by the wheel brakes (in addition to airbrakes and thrust reversers). Braking events during taxiing and landing require a significant amount of kinetic energy of the aircraft to be dissipated. This kinetic energy is converted into thermal and acoustic energy by friction within the brake system.

At present, the performance of aircraft brakes is monitored and reported by the aircraft flight crew and ground crew. For example, the flight crew are aware if certified stopping distances are not met. Abnormal brake temperature detected by onboard sensors may be indicative of brake performance problems. Asymmetric braking is also indicative of a performance problem with one of the braking systems. Regular visual inspections of the brake systems are also carried out by ground crew to look for visual indicators (e.g. uneven or excessive wear).

It will be noted that significant redundancy is built into aircraft braking systems such that a poorly performing brake is accounted for by other brakes on the aircraft. Such redundancy ensures that detrimental brake performance does not affect the ability of the aircraft to come to a full and complete stop. Nevertheless, proper monitoring of brake performance degradation before the above mentioned effects become noticeable would be beneficial so that inspection and service can be scheduled into the aircraft's flight plan. Expensive, inconvenient and unexpected delays due to servicing can thereby be avoided.

It is an object of the present invention to provide a brake monitoring method and apparatus which mitigates the above mentioned problems, and provides a warning should aircraft brake performance begin to degrade.

According to a first aspect of the invention there is provided a method of monitoring the performance of an aircraft wheel brake comprising the steps of:
providing an aircraft having a wheel brake,
measuring brake performance input variable data during a braking operation,
calculating an energy demand to be absorbed by the brake over at least part of the braking operation using the brake control input variable data,
measuring brake performance output variable data during the braking operation,
calculating an energy absorbed by the brake over at least part of the braking operation using the brake performance output variable data,
determining a brake performance metric from the energy demand and the energy absorbed,
comparing the brake performance metric with a brake performance criterion to detect impaired performance of the brake.

Advantageously, the above method provides a metric which can be compared to an ideal, or performing brake system. If the brake performance indicator falls outside the expected, or ideal, range, then the brake can be scheduled for service at the next appropriate occasion.

Preferably the brake performance input variable is brake demand.

Preferably the brake performance input variable is brake servo pressure. Brake servo pressure is then converted to an estimated brake torque demand.

The estimated brake torque demand may be a percent (%) brake torque demand.

Preferably the method comprises the steps of:
providing a braked wheel arranged to be braked by the brake,
recording the speed of the braked wheel during the braking operation,
using the braked wheel speed to calculate the energy demand.

Preferably the step of calculating the energy demand comprises the steps of:
multiplying the estimated brake torque demand by the speed of the braked wheel to calculate power demand data,
integrating the power demand data over time to calculate the energy demand.

The use of the wheel speed in the calculation helps to eliminate events such as wheel slip or skid from affecting the calculation.

Preferably the brake performance output variable is brake torque.

Preferably brake torque is measured at the brake.

Preferably the method comprises the steps of:
providing a braked wheel arranged to be braked by the brake,
monitoring the speed of the braked wheel during the braking operation,
using the braked wheel speed to calculate the energy absorbed.

Preferably the method comprises the steps of.
multiplying the brake torque by the speed of the braked wheel to calculate power absorbed data,
integrating the power absorbed data over time to calculate the energy absorbed.

Preferably the brake performance indicator is a brake energy differential between (i) the energy absorbed and (ii) an expected energy absorbed for a healthy brake, for the given energy demand.

Preferably the brake performance criterion is at least three standard deviations of a normal distribution of brake energy differentials from a relationship between energy demand and energy absorbed for a healthy brake.

Preferably an alert is produced if impaired performance of the brake is detected.

According to a second aspect of the invention there is provided an aircraft wheel brake monitoring apparatus comprising:
a memory,
a first sensor arranged to measure brake performance input variable data during a braking operation and send the brake performance input variable data to the memory,
a second sensor arranged to measure brake performance output variable data during the braking operation and send the brake performance output variable data to the memory,
a processor arranged to access the memory and configured to;
(i) calculate energy demand to be absorbed by the brake over at least part of a braking operation using the brake control input variable data,
(ii) calculate energy absorbed by the brake over at least part of a braking operation using the brake performance output variable data,
(iii) calculate a brake performance metric from the energy demand and the energy absorbed, and,
(iv) compare the brake performance metric with a brake performance criterion to detect impaired performance of the brake.

By using the brake speed in the energy demand calculation, erroneous results due to wheel lock/skidding can be avoided, which would otherwise cause a large difference in energy demand and actual energy absorbed.

An example method and apparatus, in accordance with the present invention, will now be described with reference to the following Figures:

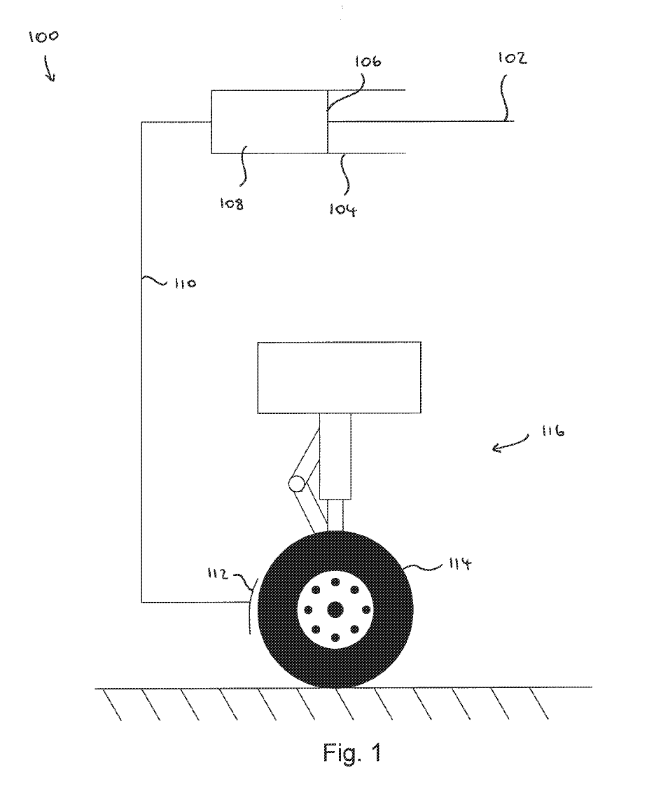

FIG. 1 is a simplified schematic view of an aircraft landing gear braking system;

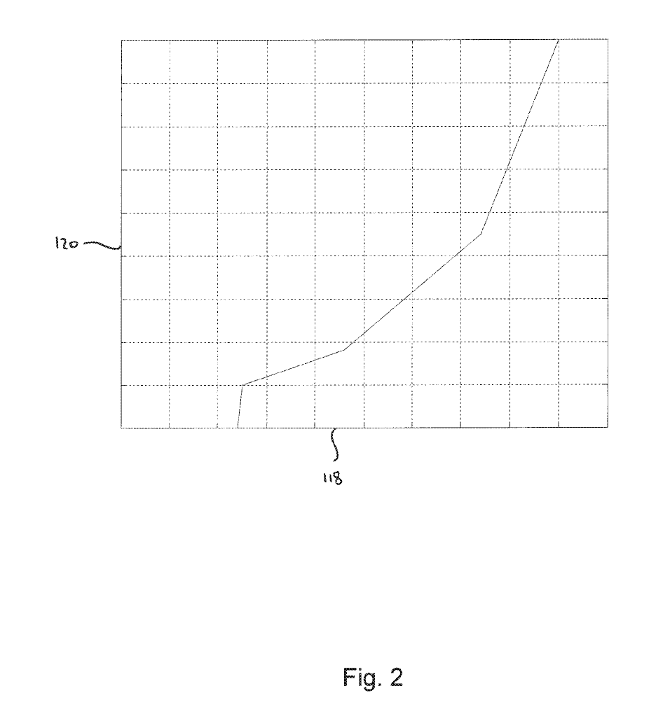

FIG. 2 is an example plot of brake pedal demand versus brake servo pressure;

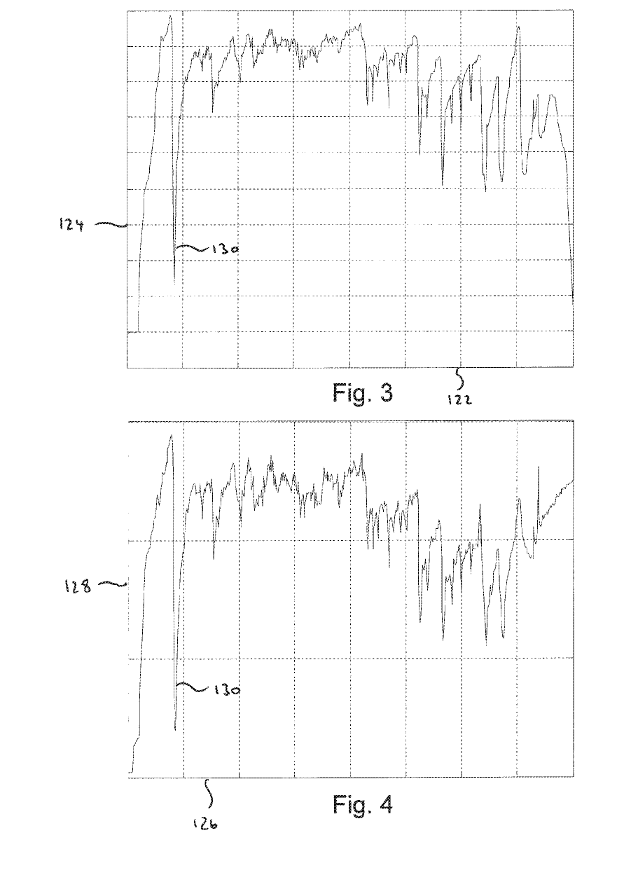

FIG. 3 is a plot of the brake torque over time during a braking operation;

FIG. 4 is a plot of brake servo pressure over time during the braking operation of FIG. 3;

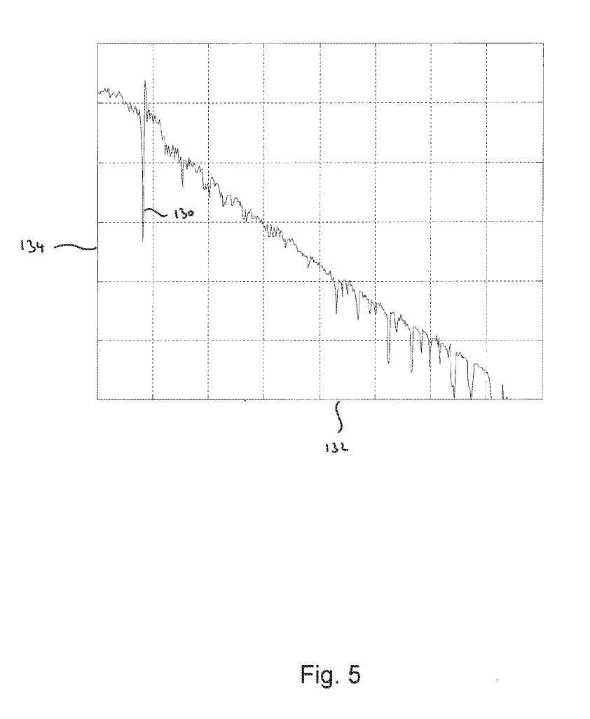

FIG. 5 is a plot of wheel speed over time during the braking operation of FIG. 3;

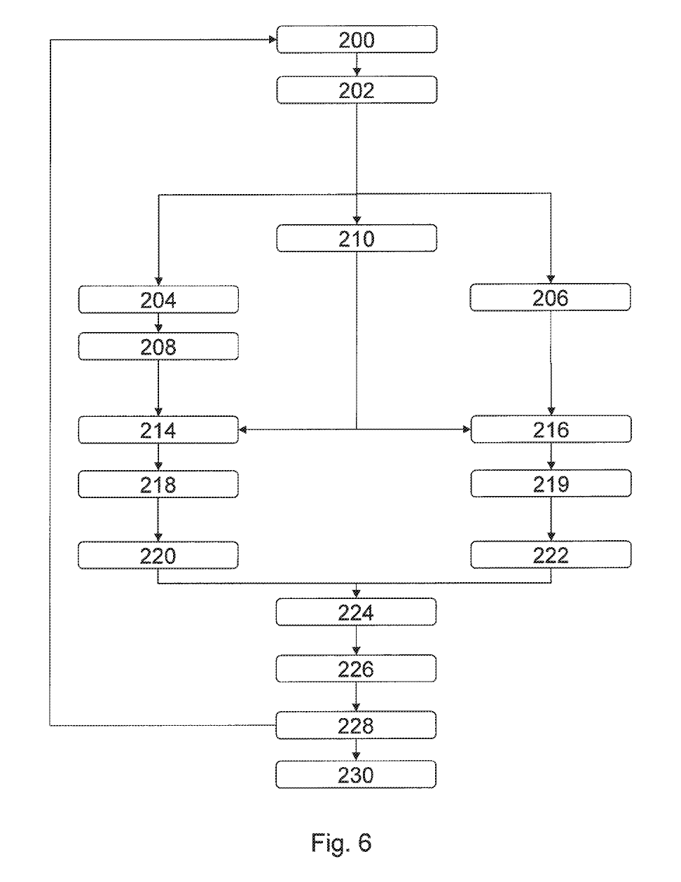

FIG. 6 is a flow chart of a method in accordance with the present invention;

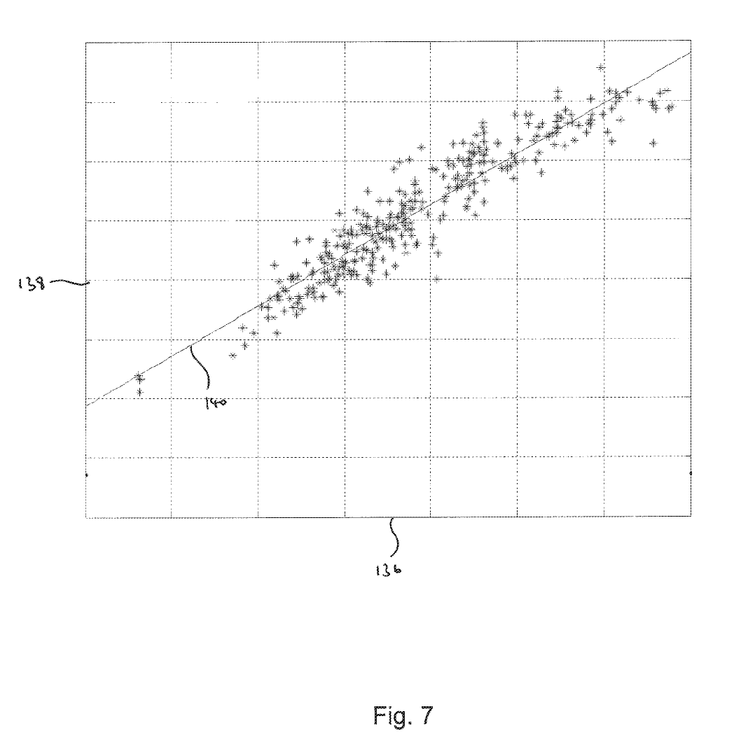

FIG. 7 is a plot of pseudo energy demand versus energy absorbed for a plurality of braking operations;

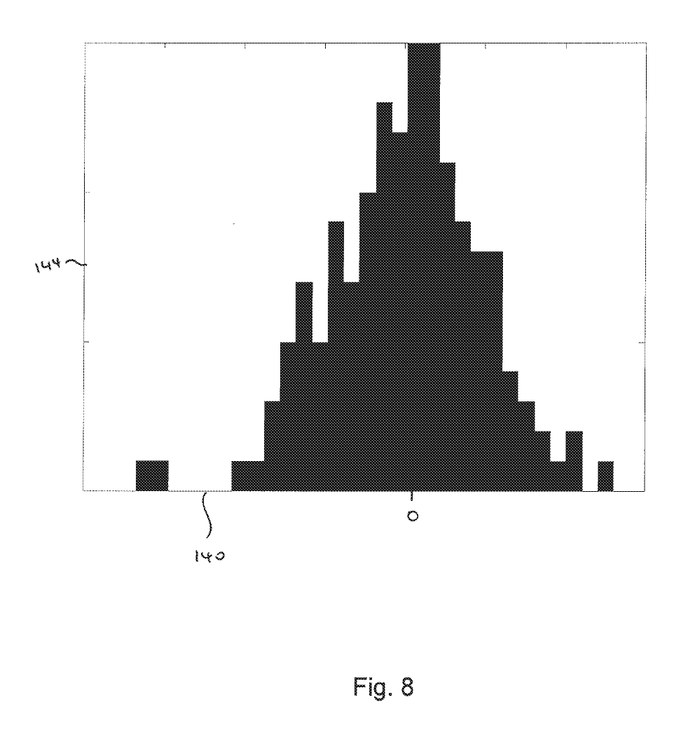

FIG. 8 is a histogram of energy residuals for the plot of FIG. 7; and

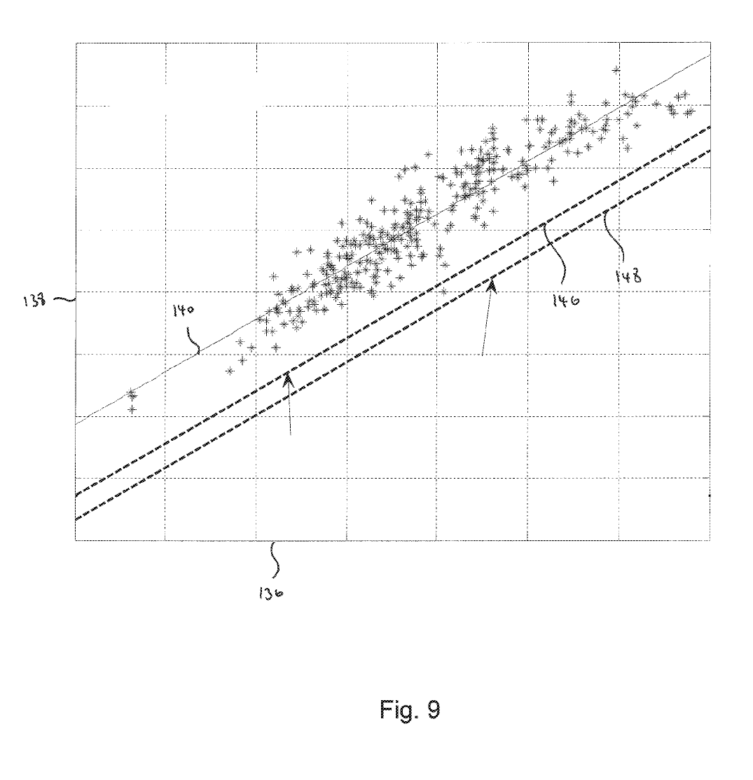

FIG. 9 is a plot similar to that of FIG. 7 with multiples of the standard deviation of the statistical model of FIG. 8 plotted thereon.

Turning to FIG. 1 there is provided an aircraft braking system 100 comprising a mechanical input 102. This is, for example, a brake pedal operated by the pilot. The input 102 is connected to a hydraulic master cylinder 104 via a servomechanism (not shown) comprising a piston 106 arranged to pressurise a working chamber 108. The working chamber 108 is in fluid communication with a brake line 110 which in turn is connected to a slave cylinder of a brake caliper 112 which is arranged to slow a wheel 114 of a landing gear 116 in order to decelerate the aircraft.

The present invention is based on the ability to compare an energy demand (from the pilot) to the actual energy used by the brakes during a braking operation.

Because energy is not directly measurable, appropriate input and output variables need to be measured and used to estimate the energy demand and usage at the brake.

In terms of energy demand, this can be estimated (“pseudo” energy demand) using the input variable of torque demand applied by the pilot. In this embodiment, this torque demand is not directly measured but instead is estimated from the brake servo pressure in chamber 108.

A pressure transducer in the chamber 108 measures brake servo pressure. A plot of servo pressure over time can be seen in FIG. 4.

Referring to FIG. 4, a variation in brake servo pressure over time can be seen with time plotted on the x-axis 126 and servo pressure on the y-axis 128. It will be noted, for example, that a skid event 130 can be observed in which servo pressure drops.

In order to convert the servo pressure to torque demand, a linear relationship is assumed. Turning to FIG. 2 the x-axis 118 represents pilot brake pedal demand ranging from 0 to 100 percent. The y-axis 120 represents the servo pressure created in the working chamber 108 as a result.

As can be seen, the relationship is almost linear. Therefore, by normalising the pressure characteristic to have a minimum of 0 and maximum 100, an estimated “pseudo” torque demand characteristic in percent (%) can be derived.

For actual energy used at the brake, torque sensors are supplied on modern braking systems and, as such, the torque applied by a brake over a given braking event can be plotted, as shown in FIG. 3. The x-axis 122 represents time and the y-axis 124 represents braking torque.

In order to convert the pseudo torque demand and the torque at the brake to a pseudo energy demand and energy absorbed, the wheel speed is required.

A typical landing gear comprises a speed sensor and, referring to FIG. 5, a variation in wheel speed is shown over time with time, plotted on the x-axis 132, and wheel speed on the y-axis 134. It will be noted that the skid event 130 is also visible on this graph.

Multiplication of each of the torque characteristics (FIGS. 3 and 4) with the speed characteristic (FIG. 5) results in a power versus time plot. In the case of the pseudo power demand, this will be in units of %·m/s (percent metres per second). In the case of the actual torque used this will be in units of N·m/s, or Watts.

Integration of these plots over the entire braking operation provides the pseudo energy demand (in %·m) and an actual energy dissipated at the brake (in Joules).

As will be described below, a given pseudo energy demand (in %·m) will provide a specific actual energy dissipated at the brake (in Joules). In other words for a healthy brake there is a relationship between these two metrics. Deviation from that relationship indicates impairment of brake performance (this is expanded upon below).

Referring to FIG. 6, a typical automated method of determining the performance metric for the brake is shown. In step 200, the start of a braking event is detected by an appropriate sensor (this may be the servo pressure transducer and/or the brake torque sensor). In step 202, appropriate data files are created in the memory of an onboard computer. In steps 204, 206 and 210 brake servo pressure, torque and speed at the wheel respectively are recorded during the braking event. In step 208 brake servo pressure is converted to estimated torque demand as described above (i.e. by applying the linear pressure-torque demand model).

At step 214 the estimated torque demand 208 is multiplied by the wheel speed 210 to provide the power demand characteristic.

At step 216 the torque at the wheel 206 is multiplied by the wheel speed 210 to provide the actual power characteristic.

At steps 218 and 219 the power characteristics are integrated over the braking event to produce a total estimated energy demand 220 and total energy absorbed 222 respectively.

At step 224, these two values are compared in order to produce a performance metric in the form of an energy differential 226. The energy differential is the amount by which the actual energy absorbed differs from an expected energy absorbed given the pseudo energy demand. At step 228, the energy differential is compared to a statistical model (as will be described below) in order to determine brake performance. If brake performance is outside the expected range then an alert is produced at step 230. Otherwise, the system returns to a dormant state until the next braking operation.

The brake performance metric is the difference between an expected energy absorbed and the actual energy absorbed at the brake (i.e. an energy differential).

The applicant has discovered that the relationship between pseudo energy demand and the actual energy absorbed follows a linear relationship for a healthy brake over a series of braking operations. Referring to FIG. 7, pseudo-energy demand is plotted on x-axis 136 versus actual energy absorbed on y-axis 138 for a multitude of braking events for healthy brakes. As can be seen, there is an approximate linear relationship 140 between these two figures. Any deviation from this ideal relationship is indicative of detrimental performance of the brake.

Turning to FIG. 8, a histogram of brake energy differential (i.e. the difference between the actual energy absorbed and the ideal relationship 140) is plotted on the x-axis 142 with frequency on the y-axis 144. As can be seen, this follows a normal distribution having a mean of 0 and a standard deviation s.

Turning to FIG. 9, this plot is identical to that of FIG. 8, but with a linear plot of three standard deviations 146 and four standard deviations 148 below the line 140. As can be seen, it is rare for the actual energy absorbed to drop three standard deviations below the expected value for a healthy brake (represented by line 140) and even rarer to drop four standard deviations below the line 140. The probability of the differential being over three standard deviations is 1 in 373, and over four standard deviations is 1 in 15787. As such, these values represent a suitable indicator of when a brake is malfunctioning.

The system can be modified to produce an alert should the brake pressure differential fall outside three standard deviations more than once in a given number of braking events, thus indicating a repetitive problem with the brake. This would also eliminate false alerts from statistical anomalies.

Variations fall within the scope of the present invention. It will be noted that alternative methods of braking control (such as electronically actuated braking) are known in the art and this invention is equally applicable to those systems. Input to the system may also be provided via an automated system such as the aircraft auto-pilot. Instead of measuring brake servo pressure, the brake demand could be determined by actuation of the mechanical system by the pilot or autopilot as measured by a movement transducer.

1. An airplane, comprising:
landing gear including:
a wheel;
a strut; and
a brake, wherein
the airplane includes sensors configured to sense phenomenon associated with braking the airplane, and wherein the airplane is configured to calculate energy absorbed by the wheel brake.

2. The airplane of claim 1, wherein the airplane includes a brake pedal.

3. The airplane of claim 1, wherein the airplane includes a brake pedal configured to be operated by a pilot of the airplane.

4. The airplane of claim 1, further comprising a hydraulic master cylinder.

5. The airplane of claim 1, further comprising a servomechanism comprising a piston arranged to pressurize a working chamber of the airplane.

6. The airplane of claim 1, wherein the brake includes a brake caliper arranged to slow the wheel.

7. The airplane of claim 1, wherein the brake includes a brake caliper arranged to slow the wheel to decelerate the airplane.

8. The airplane of claim 1, further comprising a pressure transducer.

9. The airplane of claim 1, wherein the landing gear includes a speed sensor.

10. The airplane of claim 1, wherein the brake is configured to generate heat when braking.

11. An aircraft landing gear braking system comprising:
an aircraft landing gear comprising:
a wheel; and
a wheel brake for braking the wheel; and
an aircraft wheel brake monitoring apparatus comprising:
a memory;
a first sensor arranged to measure wheel brake control input variable data over a braking event and send the wheel brake control input variable data to the memory;
a second sensor arranged to measure wheel brake performance output variable data over the braking event and send the wheel brake performance output variable data to the memory; and
a processor arranged to access the memory and configured to;
(i) calculate a total pseudo-energy demand to be absorbed by the wheel brake over the at least part of the braking event from the wheel brake control input variable data,
(ii) calculate a total energy absorbed by the wheel brake over at least part of the braking event from the wheel brake performance output variable data,
(iii) calculate a wheel brake energy differential from the total pseudo-energy demand and the total energy absorbed over the braking event, and,
(iv) compare the wheel brake energy differential with a wheel brake performance criterion to detect impaired performance of the wheel brake.

12. An aircraft landing gear braking system according to claim 11, wherein the second sensor is a brake torque sensor, and wherein the measured wheel brake performance output variable is wheel brake torque.

13. An aircraft landing gear braking system according to claim 12, wherein the wheel brake torque is measured at the wheel brake.

14. An aircraft landing gear braking system according to claim 13, wherein the wheel brake control input variable data is an estimated wheel brake torque demand.

15. An aircraft landing gear braking system according to claim 14, the aircraft wheel brake monitoring apparatus comprising a speed sensor arranged to measure, for the wheel, wheel speed over the braking event and send the wheel speed to the memory,
wherein the processor is configured to:
calculate the total pseudo-energy demand to be absorbed from the wheel speed by multiplying the estimated wheel brake torque demand by the speed of the braked wheel to calculate power demand data and integrating the power demand data over the braking event; and
calculate the total energy absorbed by the wheel brake from the braked wheel speed by multiplying the wheel brake torque by the speed of the braked wheel to calculate power absorbed data and integrating the power absorbed data over the braking event.

16. An aircraft landing gear braking system according to claim 11, wherein the wheel brake performance criterion is a statistical model of normal wheel brake performance.

17. An aircraft landing gear braking system according to claim 16, wherein the impaired performance of the wheel brake is detected when the wheel brake energy differential falls outside three standard deviations of the statistical model of a normal wheel brake performance.

18. An aircraft landing gear braking system according to claim 11, configured to produce an alert if impaired performance of the wheel brake is detected more than once in a given number of braking events.

19. An aircraft comprising an aircraft landing gear braking system according to claim 11.
